(19) United States
(12) Patent Application Publication
(10) Pub. No.: US 2013/0093740 A1
(43) Pub. Date: Apr. 18, 2013

(54) LIQUID CRYSTAL ARRAY AND LIQUID CRYSTAL DISPLAY PANEL

(71) Applicant: Jin-jie Wang, Shenzhen (CN)

(72) Inventor: Jin-jie Wang, Shenzhen (CN)

(73) Assignee: SHENZHEN CHINA STAR OPTOELECTRONICS TECHNOLOGY CO LTD., Shenzhen (CN)

(21) Appl. No.: 13/376,592

(22) PCT Filed: Oct. 18, 2011
(86) PCT No.: PCT/CN11/80876

§ 371 Date: Dec. 7, 2011

(30) Foreign Application Priority Data
Oct. 14, 2011 (CN) 201110312934.5

(51) Int. Cl. G09G 3/36; G06F 3/038

(52) U.S. Cl. 345/211; 345/87

(57) ABSTRACT

A liquid crystal array comprises a (2N−1)^{th} and a 2N^{th} gate line, where N is a positive integer. An area between the (2N−1)^{th} and the 2N^{th} gate lines comprises pixels arranged in a row direction. Said array further comprises a N^{th} wiring extension line, a (2N−1)^{th} and a 2N^{th} switch elements; the (2N−1)^{th} gate line is connected to the N^{th} wiring extension line via the (2N−1)^{th} switch element, and the 2N^{th} gate line is connected to the N^{th} wiring extension line via the 2N^{th} switch element; said array further comprises a first and a second selection lines, the first selection line controls a voltage inputted to the (2N−1)^{th} gate line by the (2N−1)^{th} switch element, the second selection line controls a voltage inputted to the 2N^{th} gate line by the 2N^{th} switch element. The present invention can reduce the number of wiring extension lines, improve space utilization, and reduce cost.

### TECHNICAL FIELD OF THE INVENTION

The present invention relates to a technical filed of a liquid crystal displaying technique, and more particularly, to a liquid crystal array and a liquid crystal display panel.

### BACKGROUND OF THE INVENTION

As liquid crystal displays (LCD) are widely used, the performance of the liquid crystal displays required by users is higher and higher.

In conventional skills, taking a liquid crystal panel of a resolution M×N for example, the number of gate wiring extension lines and the number of source wiring extension lines of the liquid crystal panel are respectively N and 3M under a single gate driving mode. Assuming that the channel number of a gate driving IC and the channel number of a source driving IC are respectively a and b, the display product needs N/a pieces of gate driving ICs and 3M/b pieces of source driving ICs.

Also, the higher the resolution of the liquid crystal display panel, the greater the number of the wiring extension lines. This will make the space of the liquid crystal panel occupied by the wiring extension lines increased, and the number of the driving ICs is increased as well. It not merely reduces space utilization, but also wastes the resources.

How to reduce the number of wiring extension lines of the liquid crystal panel, improve space utilization, and reduce manufacturing cost is an important aspect in the liquid crystal displaying technical field.

### SUMMARY OF THE INVENTION

An objective of the present invention is to provide a liquid crystal array for reducing the number of wiring extension lines in a liquid crystal panel, improving space utilization of the liquid crystal panel, and reducing manufacturing cost.

To achieve the above beneficial effects, the present invention provides a liquid crystal array, comprising a (2N−1)^{th} gate line and a 2N^{th} gate line, where N is a positive integer, an area between the (2N−1)^{th} gate line and the 2N^{th} gate line comprising a plurality of pixels arranged in a row direction.
said liquid crystal array further comprises a N^{th} wiring extension line, a (2N−1)^{th} switch element, and a 2N^{th} switch element;
the (2N−1)^{th} gate line is connected to the N^{th} wiring extension line via the (2N−1)^{th} switch element, and the 2N^{th} gate line is connected to the N^{th} wiring extension line via the 2N^{th} switch element;
said liquid crystal array further comprises a first selection line and a second selection line, the first selection line comprises a first left selection line and a first right selection line, the second selection line comprises a second left selection line and a second right selection line, the first selection line controls a voltage inputted to the (2N−1)^{th} gate line by utilizing the (2N−1)^{th} switch element, the second selection line controls a voltage inputted to the 2N^{th} gate line by utilizing the 2N^{th} switch element;
when the first left selection line provides a first voltage level, the second left selection line provides a second voltage level, the first right selection line provides the second voltage level, and the second right selection line provides the first voltage level; or
when the first left selection line provides the second voltage level, the second left selection line provides the first voltage level, the first right selection line provides the first voltage level, and the second right selection line provides the second voltage level.

In the liquid crystal panel of the present invention, the first voltage level is higher than the second voltage level.

In the liquid crystal panel of the present invention, the (2N−1)^{th} switch element comprises a (2N−1)^{th} left switch element and a (2N−1)^{th} right switch element, and the 2N^{th} switch element comprises a 2N^{th} left switch element and a 2N^{th} right switch element, wherein the (2N−1)^{th} left switch element and the 2N^{th} left switch element are connected to the N^{th} wiring extension line, and the (2N−1)^{th} right switch element and the 2N^{th} right switch element are connected to a gate voltage selection line of said liquid crystal array.

Another objective of the present invention is to provide a liquid crystal array for reducing the number of wiring extension lines in a liquid crystal panel, improving space utilization of the liquid crystal panel, and reducing manufacturing cost.

To achieve the above beneficial effects, the present invention provides a liquid crystal array, comprising a (2N−1)^{th} gate line and a 2N^{th} gate line, where N is a positive integer, an area between the (2N−1)^{th} gate line and the 2N^{th} gate line comprising a plurality of pixels arranged in a row direction.
said liquid crystal array further comprises a N^{th} wiring extension line, a (2N−1)^{th} switch element, and a 2N^{th} switch element;
the (2N−1)^{th} gate line is connected to the N^{th} wiring extension line via the (2N−1)^{th} switch element, and the 2N^{th} gate line is connected to the N^{th} wiring extension line via the 2N^{th} switch element;
said liquid crystal array further comprises a first selection line and a second selection line, the first selection line controls a voltage inputted to the (2N−1)^{th} gate line by utilizing the (2N−1)^{th} switch element, the second selection line controls a voltage inputted to the 2N^{th} gate line by utilizing the 2N^{th} switch element.

In the liquid crystal panel of the present invention, the first selection line comprises a first left selection line and a first right selection line, the second selection line comprises a second left selection line and a second right selection line; the first left selection line, the first right selection line, the second left selection line, and the second right selection line provide a first voltage level or a second voltage level according to a predetermined time sequence, wherein the first voltage level is higher than the second voltage level.

In the liquid crystal panel of the present invention, when the first left selection line provides the first voltage level, the second left selection line provides the second voltage level, the first right selection line provides the second voltage level, and the second right selection line provides the first voltage level.

In the liquid crystal panel of the present invention, when the first left selection line provides the second voltage level, the second left selection line provides the first voltage level, the first right selection line provides the first voltage level, and the second right selection line provides the second voltage level.

In the liquid crystal panel of the present invention, the (2N−1)^{th} switch element comprises a (2N−1)^{th} left switch element and a (2N−1)^{th} right switch element, and the 2N^{th} switch element comprises a 2N^{th} left switch element and a 2N^{th} right switch element, wherein the (2N−1)^{th} left switch element and the 2N^{th} left switch element are connected to the N^{th} wiring extension line, and the (2N−1)^{th} right switch element and the 2N^{th} right switch element are connected to a gate voltage selection line of said liquid crystal array.

Still another objective of the present invention is to provide a liquid crystal display panel for reducing the number of wiring extension lines, improving space utilization, and reducing manufacturing cost.

To achieve the above beneficial effects, the present invention provides a liquid crystal display panel, comprising a liquid crystal array, said liquid crystal array comprising a (2N−1)^{th} gate line and a 2N^{th} gate line, where N is a positive integer, an area between the (2N−1)^{th} gate line and the 2N^{th} gate line comprising a plurality of pixels arranged in a row direction.
said liquid crystal array further comprises a N^{th} wiring extension line, a (2N−1)^{th} switch element, and a 2N^{th} switch element;
the (2N−1)^{th} gate line is connected to the N^{th} wiring extension line via the (2N−1)^{th} switch element, and the 2N^{th} gate line is connected to the N^{th} wiring extension line via the 2N^{th} switch element;
said liquid crystal array further comprises a first selection line and a second selection line, the first selection line controls a voltage inputted to the (2N−1)^{th} gate line by utilizing the (2N−1)^{th} switch element, the second selection line controls a voltage inputted to the 2N^{th} gate line by utilizing the 2N^{th} switch element.

In the liquid crystal display panel of the present invention, the first selection line comprises a first left selection line and a first right selection line, the second selection line comprises a second left selection line and a second right selection line; the first left selection line, the first right selection line, the second left selection line, and the second right selection line provide a first voltage level or a second voltage level according to a predetermined time sequence, wherein the first voltage level is higher than the second voltage level.

In the liquid crystal display panel of the present invention, when the first left selection line provides the first voltage level, the second left selection line provides the second voltage level, the first right selection line provides the second voltage level, and the second right selection line provides the first voltage level.

In the liquid crystal display panel of the present invention, when the first left selection line provides the second voltage level, the second left selection line provides the first voltage level, the first right selection line provides the first voltage level, and the second right selection line provides the second voltage level.

In the liquid crystal display panel of the present invention, the (2N−1)^{th} switch element comprises a (2N−1)^{th} left switch element and a (2N−1)^{th} right switch element, and the 2N^{th} switch element comprises a 2N^{th} left switch element and a 2N^{th} right switch element, wherein the (2N−1)^{th} left switch element and the 2N^{th} left switch element are connected to the N^{th} wiring extension line, and the (2N−1)^{th} right switch element and the 2N^{th} right switch element are connected to a gate voltage selection line of said liquid crystal array.

Compared to conventional skills, the present invention can reduce the number of wiring extension lines in the liquid crystal panel, improve space utilization of the liquid crystal panel, and reduce manufacturing cost.

To make above content of the present invention more easily understood, it will be described in details by using preferred embodiments in conjunction with the appending drawings.

### BRIEF DESCRIPTION OF THE DRAWINGS

FIG. 1 is a structural diagram showing a liquid crystal array according to a preferred embodiment of the present invention.

FIG. 2 is a structural diagram showing switch elements in the present invention.

FIG. 3 is a schematic diagram showing a predetermined time sequence in the embodiments of the present invention.

### DETAILED DESCRIPTION OF THE INVENTION

The following descriptions for the respective embodiments are specific embodiments capable of being implemented for illustrations of the present invention with referring to appended figures.

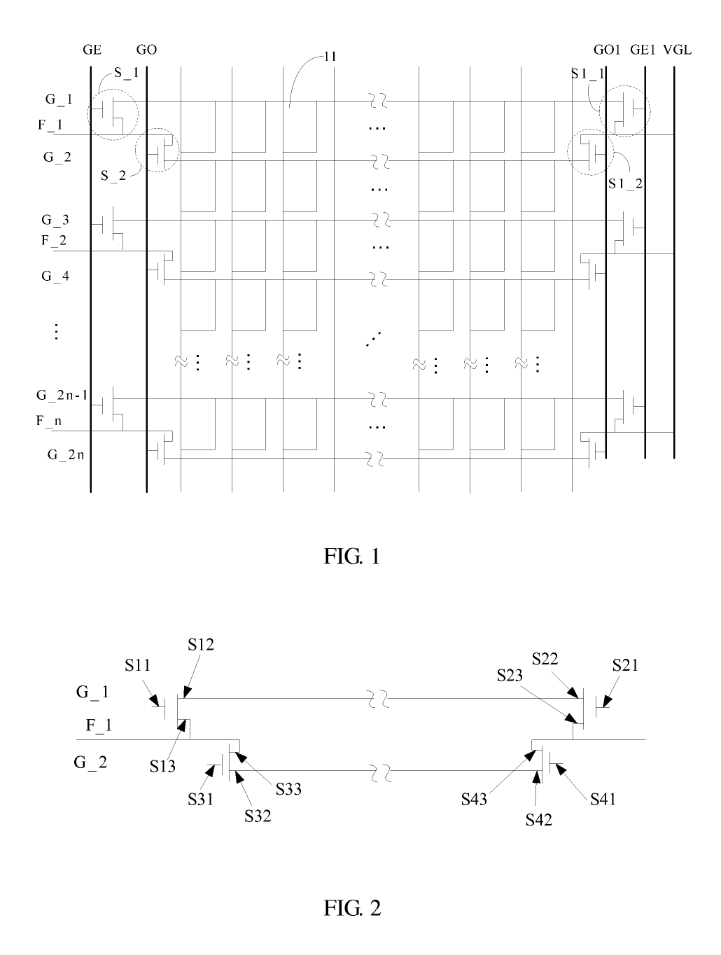

FIG. 1 is a structural diagram showing a liquid crystal array according to a preferred embodiment of the present invention.

The liquid crystal array comprises a (2N−1)^{th} gate line G_{—}2n−1 and a 2N^{th} gate line G_{—}2n, where N is a positive integer. An area between the (2N−1)^{th} gate line G_{—}2n−1 and the 2N^{th} gate line G_{—}2n comprises a plurality of pixels 11 arranged in a row direction.

In the embodiment shown in FIG. 1, the liquid crystal array further comprises a N^{th} wiring extension line F_n, a (2N−1)^{th} switch element, and a 2N^{th} switch element. In the present embodiment, the (2N−1)^{th} switch element comprises a (2N−1)^{th} left switch element S_{—}2n−1 and a (2N−1)^{th} right switch element S1_{—}2n−1; and the 2N^{th} switch element comprises a 2N^{th} left switch element S_{—}2n and a 2N^{th} right switch element S1_{—}2n.

Referring to FIG. 1, the liquid crystal array further comprises a first selection line and a second selection line. The first selection line comprises a first left selection line GE and a first right selection line GE1; the second selection line comprises a second left selection line GO and a second right selection line GO1.

Referring to FIG. 2, a first left switch element S_{—}1, a first right switch element S1_{—}1, a second left switch element S_{—}2, and a second right switch element S1_{—}2 are illustrated for example. The first left switch element S_{—}1 comprises a first terminal S11, a second terminal S12, and a third terminal S13; the first right switch element S1_{—}1 comprises a first terminal S21, a second terminal S22, and a third terminal S23; the second left switch element S_{—}2 comprises a first terminal S31, a second terminal S32, and a third terminal S33; the second right switch element S1_{—}2 comprises a first terminal S41, a second terminal S42, and a third terminal S43.

The (2N−1)^{th} gate line G_{—}2n−1 is connected to the second terminal S12 of the (2N−1)^{th} left switch element S_{—}2n−1 and the second terminal S22 of the (2N−1)^{th} right switch element S1_{—}2n−1; the 2N^{th} gate line G_{—}2n is connected to the second terminal S32 of the 2N^{th} left switch element S_{—}2n and the second terminal S42 of the 2N^{th} right switch element S1_{—}2n.

The third terminal S13 of the (2N−1)^{th} left switch element S_{—}2n−1 and the third terminal S33 of the 2N^{th} left switch element S_{—}2n are connected to the N^{th} wiring extension line F_n; the third terminal S23 of the (2N−1)^{th} right switch element S1_{—}2n−1 and the third terminal S43 of the 2N^{th} right switch element S1_{—}2n are connected to a gate voltage selection line VGL.

The first terminal S11 of the (2N−1)^{th} left switch element S_{—}2n−1 is connected to the first left selection line GE; the first terminal S31 of the 2N^{th} left switch element S_{—}2n is connected to the second left selection line GO; the first terminal S21 of the (2N−1)^{th} right switch element S1_{—}2n−1 is connected to the first right selection line GE1; the first terminal S41 of the 2N^{th} right switch element S1_{—}2n is connected to the second right selection line GO1.

The first left selection line GE, the first right selection line GE1, the second left selection line GO, and the second right selection line GO1 provide a first voltage level H or a second voltage level L according to a predetermined time sequence, wherein the first voltage level H is higher than the second voltage level L.

In the present embodiment, the first left selection line GE and the first right selection line GE1 control a voltage inputted to the (2N−1)^{th} gate line respectively by utilizing the (2N−1)^{th} left switch element S_{—}2n−1 and the (2N−1)^{th} right switch element S1_{—}2n−1; the second left selection line GO and the second right selection line GO1 control a voltage inputted to the 2N^{th} gate line respectively by utilizing the 2N^{th} left switch element S_{—}2n and the 2N^{th} right switch element S1_{—}2n.

In the embodiment shown in FIG. 1, when the first left selection line GE provides the first voltage level, the second left selection line GO provides the second voltage level, the first right selection line GE1 provides the second voltage level, and the second right selection line GO1 provides the first voltage level.

In the embodiment shown in FIG. 1, when the first left selection line GE provides the second voltage level, the second left selection line GO provides the first voltage level, the first right selection line GE1 provides the first voltage level, and the second right selection line GO1 provides the second voltage level.

The more concrete working process of the preferred embodiment of the present invention is described below.

At the moment T1, the first left selection line GE is inputted with the first voltage level H, the second left selection line GO is inputted with the second voltage level L, a first wiring extension line F_{—}1 is inputted with the first voltage level H, a second wiring extension line F_{—}2 to the N^{th} wiring extension line F_n are inputted with the second voltage level L, the second right selection line GO1 is inputted with the first voltage level H, the first right selection line GE1 is inputted with the second voltage level L, and the gate voltage selection line VGL maintains at the second voltage level L.

Since the first left selection line GE is inputted with the first voltage level H, a signal on the first wiring extension line F_{—}1 can be transmitted to the first gate line G_{—}1 to turn on thin film transistors (TFTs) corresponding to the first gate line G_{—}1. At this moment, the second voltage level L signal of the gate voltage selection line VGL will not enter the first gate line G_{—}1 since the first right selection line GE1 is inputted with the second voltage level L.

At the same time, the first voltage level H signal of the first wiring selection line F_{—}1 can not enter the second gate line G_{—}2 since the second left selection line GO is inputted with the second voltage level L. The second voltage level L signal of the gate voltage selection line VGL will enter the second gate line G_{—}2 since the second right selection line GO1 is inputted with the first voltage level H.

At the same time, a second wiring extension line F_{—}2 is inputted with the second voltage level L. Since the first left selection line GE is inputted with the first voltage level H, the second voltage level L signal of the second wiring extension line F_{—}2 will enter the third gate line G_{—}3. Also, the second voltage level L signal of the gate voltage selection line VGL will enter the fourth gate line G_{—}4 since the second right selection line GO1 is inputted with the first voltage level H.

The working processes of a third wiring extension line F_{—}3 to the N^{th} wiring extension line F_n are similar to above descriptions, and therefore the descriptions regarding this part are omitted herein.

At the moment T2, the first left selection line GE is inputted with the second voltage level L, the second left selection line GO is inputted with the first voltage level H, the first wiring extension line F_{—}1 is inputted with the first voltage level H, the second wiring extension line F_{—}2 to the N^{th} wiring extension line F_n are inputted with the second voltage level L, the second right selection line GO1 is inputted with the second voltage level L, the first right selection line GE1 is inputted with the first voltage level H, and the gate voltage selection line VGL maintains at the second voltage level L.

Since the second left selection line GO is inputted with the first voltage level H, a signal on the first wiring extension line F_{—}1 will enter the second gate line G_{—}2 to turn on TFTs corresponding to the second gate line G_{—}2. At this moment, the second voltage level L signal of the gate voltage selection line VGL will not enter the second gate line G_{—}2 since the second right selection line GO1 is inputted with the second voltage level L.

At the same time, the first voltage level H signal of the first wiring selection line F_{—}1 can not enter the first gate line G_{—}1 since the first left selection line GE is inputted with the second voltage level L. The second voltage level L signal of the gate voltage selection line VGL will enter the first gate line G_{—}1 since the first right selection line GE1 is inputted with the first voltage level H.

At the same time, the second wiring extension line F_{—}2 is inputted with the second voltage level L. Since the second left selection line GO is inputted with the first voltage level H, the second voltage level L signal of the second wiring extension line F_{—}2 will enter the fourth gate line G_{—}4. Also, the second voltage level L signal of the gate voltage selection line VGL will enter the third gate line G_{—}3 since the first right selection line GE1 is inputted with the first voltage level H.

The working processes of a third wiring extension line F_{—}3 to the N^{th} wiring extension line F_n are similar to above descriptions, and therefore the descriptions regarding this part are omitted herein.

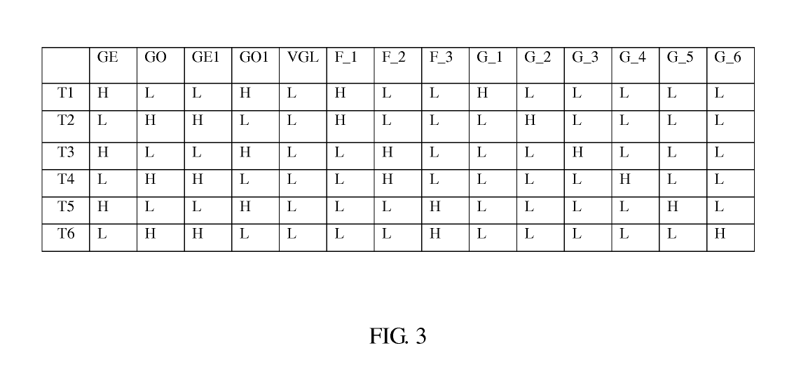

Referring to FIG. 3, FIG. 3 is a schematic diagram showing a predetermined time sequence in the present invention. Obviously, the embodiments of the present invention can carry out “opening” and “closing” the gate lines in order by presetting the signal timing to control the first selection line and the second selection line. Also, compared to the design of one gate line corresponding to one wiring extension line in conventional skills, the number of wiring extension lines of the embodiments of the present invention can be reduced by half and the number of driving chips are reduced as well since two gate lines correspond to one wiring extension line in the present invention. The present invention not merely makes the best use of the wiring space, but also reduces the cost.

The present invention further provides a liquid crystal display panel. Said liquid crystal display panel comprises the liquid crystal array provided in the embodiments of the present invention. Since the liquid crystal array is detailedly described above, the descriptions regarding this part are omitted herein.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A liquid crystal array, comprising a (2N−1)^{th} gate line and a 2N^{th} gate line, where N is a positive integer, an area between the (2N−1)^{th} gate line and the 2N^{th} gate line comprising a plurality of pixels arranged in a row direction, characterized in that:
said liquid crystal array further comprises a N^{th} wiring extension line, a (2N−1)^{th} switch element, and a 2N^{th} switch element;
the (2N−1)^{th} gate line is connected to the N^{th} wiring extension line via the (2N−1)^{th} switch element, and the 2N^{th} gate line is connected to the N^{th} wiring extension line via the 2N^{th} switch element;
said liquid crystal array further comprises a first selection line and a second selection line, the first selection line comprises a first left selection line and a first right selection line, the second selection line comprises a second left selection line and a second right selection line, the first selection line controls a voltage inputted to the (2N−1)^{th} gate line by utilizing the (2N−1)^{th} switch element, the second selection line controls a voltage inputted to the 2N^{th} gate line by utilizing the 2N^{th} switch element;
when the first left selection line provides a first voltage level, the second left selection line provides a second voltage level, the first right selection line provides the second voltage level, and the second right selection line provides the first voltage level; or
when the first left selection line provides the second voltage level, the second left selection line provides the first voltage level, the first right selection line provides the first voltage level, and the second right selection line provides the second voltage level.

2. The liquid crystal array according to claim 1, characterized in that the first voltage level is higher than the second voltage level.

3. The liquid crystal array according to claim 2, characterized in that the (2N−1)^{th} switch element comprises a (2N−1)^{th} left switch element and a (2N−1)^{th} right switch element, and the 2N^{th} switch element comprises a 2N^{th} left switch element and a 2N^{th} right switch element, wherein the (2N−1)^{th} left switch element and the 2N^{th} left switch element are connected to the N^{th} wiring extension line, and the (2N−1)^{th} right switch element and the 2N^{th} right switch element are connected to a gate voltage selection line of said liquid crystal array.

4. A liquid crystal array, comprising a (2N−1)^{th} gate line and a 2N^{th} gate line, where N is a positive integer, an area between the (2N−1)^{th} gate line and the 2N^{th} gate line comprising a plurality of pixels arranged in a row direction, characterized in that:
said liquid crystal array further comprises a N^{th} wiring extension line, a (2N−1)^{th} switch element, and a 2N^{th} switch element;
the (2N−1)^{th} gate line is connected to the N^{th} wiring extension line via the (2N−1)^{th} switch element, and the 2N^{th} gate line is connected to the N^{th} wiring extension line via the 2N^{th} switch element;
said liquid crystal array further comprises a first selection line and a second selection line, the first selection line controls a voltage inputted to the (2N−1)^{th} gate line by utilizing the (2N−1)^{th} switch element, the second selection line controls a voltage inputted to the 2N^{th} gate line by utilizing the 2N^{th} switch element.

5. The liquid crystal array according to claim 4, characterized in that the first selection line comprises a first left selection line and a first right selection line, the second selection line comprises a second left selection line and a second right selection line;
the first left selection line, the first right selection line, the second left selection line, and the second right selection line provide a first voltage level or a second voltage level according to a predetermined time sequence, wherein the first voltage level is higher than the second voltage level.

6. The liquid crystal array according to claim 5, characterized in that when the first left selection line provides the first voltage level, the second left selection line provides the second voltage level, the first right selection line provides the second voltage level, and the second right selection line provides the first voltage level.

7. The liquid crystal array according to claim 5, characterized in that when the first left selection line provides the second voltage level, the second left selection line provides the first voltage level, the first right selection line provides the first voltage level, and the second right selection line provides the second voltage level.

8. The liquid crystal array according to claim 5, characterized in that the (2N−1)^{th} switch element comprises a (2N−1)^{th} left switch element and a (2N−1)^{th} right switch element, and the 2N^{th} switch element comprises a 2N^{th} left switch element and a 2N^{th} right switch element, wherein the (2N−1)^{th} left switch element and the 2N^{th} left switch element are connected to the N^{th} wiring extension line, and the (2N−1)^{th} right switch element and the 2N^{th} right switch element are connected to a gate voltage selection line of said liquid crystal array.

9. A liquid crystal display panel, comprising a liquid crystal array, said liquid crystal array comprising a (2N−1)^{th} gate line and a 2N^{th} gate line, where N is a positive integer, an area between the (2N−1)^{th} gate line and the 2N^{th} gate line comprising a plurality of pixels arranged in a row direction, characterized in that:
said liquid crystal array further comprises a N^{th} wiring extension line, a (2N−1)^{th} switch element, and a 2N^{th} switch element;
the (2N−1)^{th} gate line is connected to the N^{th} wiring extension line via the (2N−1)^{th} switch element, and the 2N^{th} gate line is connected to the N^{th} wiring extension line via the 2N^{th} switch element;
said liquid crystal array further comprises a first selection line and a second selection line, the first selection line controls a voltage inputted to the (2N−1)^{th} gate line by utilizing the (2N−1)^{th} switch element, the second selection line controls a voltage inputted to the 2N^{th} gate line by utilizing the 2N^{th} switch element.

10. The liquid crystal display panel according to claim 9, characterized in that the first selection line comprises a first left selection line and a first right selection line, the second selection line comprises a second left selection line and a second right selection line;
the first left selection line, the first right selection line, the second left selection line, and the second right selection line provide a first voltage level or a second voltage level according to a predetermined time sequence, wherein the first voltage level is higher than the second voltage level.

11. The liquid crystal display panel according to claim 10, characterized in that when the first left selection line provides the first voltage level, the second left selection line provides the second voltage level, the first right selection line provides the second voltage level, and the second right selection line provides the first voltage level.

12. The liquid crystal display panel according to claim 10, characterized in that when the first left selection line provides the second voltage level, the second left selection line provides the first voltage level, the first right selection line provides the first voltage level, and the second right selection line provides the second voltage level.

13. The liquid crystal display panel according to claim 10, characterized in that the (2N−1)^{th} switch element comprises a (2N−1)^{th} left switch element and a (2N−1)^{th} right switch element, and the 2N^{th} switch element comprises a 2N^{th} left switch element and a 2N^{th} right switch element, wherein the (2N−1)^{th} left switch element and the 2N^{th} left switch element are connected to the N^{th} wiring extension line, and the (2N−1)^{th} right switch element and the 2N^{th} right switch element are connected to a gate voltage selection line of said liquid crystal array.
